(19) United States
(12) Patent Application Publication
(10) Pub. No.: US 2026/0228235 A1
(43) Pub. Date: Aug. 6, 2026

(54) GEOGRAPHICALLY SPLIT CONNECTION POOLING FOR DATABASES

(71) Applicant: CLOUDFLARE, INC., SAN FRANCISCO, CA (US)

(72) Inventors: Alex Dwane Robinson, Austin, TX (US); Matthew Manuel Alonso, Austin, TX (US); Emilio Assunção, Austin, TX (US); Brett Hoerner, Boulder, CO (US); Andrew James Repp, Deerfield, IL (US)

(21) Appl. No.: 19/042,942

(22) Filed: Jan. 31, 2025

(51) Int. Cl. G06F 16/27; G06F 16/2455; H04L 9/40

(52) U.S. Cl. CPC G06F 16/27; G06F 16/24552; H04L 63/0884

(57) ABSTRACT

A first server of a distributed database service establishes a database connection with a database client. The database connection is for a database that is external to the distributed database service. Establishing the database connection for the database includes performing authentication to the database. The first server receives a database query over the established database connection. Responsive to determining that the first server cannot respond to the first database query using a locally available cache, the first server proxies the database query to a second server that maintains a plurality of database connections to the database. The second server is physically closer to the database compared to the first server. The first server receives a response to the database query from the second server, and transmits the response to the database client.

### FIELD

Embodiments of the invention relate to the field of network technology; and more specifically, to geographically split connection pooling for databases.

### BACKGROUND

Traditional databases exist in a centralized location. Connecting to such a centralized database from a distributed network presents challenges. One challenge is the overhead of establishing a connection between a database client, which can typically be located in any location in the distributed network, and the database. Establishing a database connection typically includes multiple round trips (e.g., TCP handshake, TLS negotiation, and authentication). Each step in the database connection takes time including the time necessary to communicate the data between the database client and the database.

Database connection poolers exist to manage and optimize the connections between database clients and the database by maintaining a pool of active connections. This allows for the reuse of existing connections rather than establishing new connections for each request, thereby reducing the time and resources required for connection setup. In a distributed network, a connection pooler typically runs as a standalone service or proxy between database clients and the database server. A database client connects to the connection pooler. Conventional connection poolers terminate incoming client connections (including connection setup and authentication) and establish outgoing database connections for the pool on the same machine. In a distributed network, this necessitates incurring the full roundtrip costs of connection setup for the entire distance between the pool location and the database client.

### BRIEF DESCRIPTION OF THE DRAWINGS

The invention may best be understood by referring to the following description and accompanying drawings that are used to illustrate embodiments of the invention. In the drawings:

FIG. 1 illustrates a system for geographically split connection pooling for databases according to an embodiment.

FIG. 2A is a first part of a sequence diagram that illustrates exemplary operations for geographically split connection pooling for a database according to an embodiment.

FIG. 2B is a second part of the sequence diagram that illustrates exemplary operations for geographically split connection pooling for a database according to an embodiment.

FIG. 3 is a sequence diagram that illustrates exemplary operations for geographically split connection pooling for a database according to an embodiment.

FIG. 4 is a sequence diagram that illustrates exemplary operations for geographically split connection pooling for a database according to an embodiment.

FIG. 5 is a flow diagram that illustrates exemplary operations for geographically split connection pooling for a database according to an embodiment.

FIG. 6 is a flow diagram that illustrates exemplary operations for geographically split connection pooling for a database according to an embodiment.

FIG. 7 is a flow diagram that illustrates exemplary operations for geographically split connection pooling for a database according to an embodiment.

FIG. 8 is a block diagram illustrating a data processing system that can be used in an embodiment.

### DESCRIPTION OF EMBODIMENTS

Geographically split connection pooling for databases in a distributed database service is described. A connection to an origin database server is split into a client-side connection and a database-side connection. The client-side connection is made between the database client and a component at an edge server of a distributed database service. The database-side connection is made at a server that maintains a pool of database connections with the origin database.

The distributed database service includes multiple database client nodes, one or more pool nodes for a particular origin database, and may include one or more caching nodes. The client nodes are located at the edge of the distributed database service and are geographically distributed. The one or more pool nodes maintain a set of database connection pools and are typically located physically close to the origin database. The one or more caching nodes are typically located between the client nodes and the one or more pool nodes.

Unlike conventional database connection poolers that terminate the incoming client connections and create outgoing client connections for the pool on the same machine, in embodiments described herein, the initial database connection establishment occurs on a client node that is separate from the pool node. This reduces the overhead associated with the connection setup, as the roundtrip-heavy process occurs close to the database client. The only necessary roundtrips across the network are those required to serve the actual query. Thus, embodiments described herein provide a low-latency connection setup in a distributed database service by splitting the connection setup process across multiple nodes. The client nodes, located at the edge of the distributed service, handle the initial connection setup, while pool nodes, located near the origin database, maintain the database connection pools. Further, the overhead associated with creating database connections from the pool node to the origin database may be reduced. Because the pool nodes are located near the origin database, they can establish database connections for the connection pool, or create a new connection when no available connection exists in the pool, more quickly than a conventional database connection pooler that may be located farther from the origin database.

A conventional database connection pooler is placed somewhere between a database client and the database. No matter where such a conventional database connection pooler is placed (e.g., close to the database client, close to the database, or somewhere in between), the conventional database connection pooler incurs the overhead of the database connection establishment whenever a new connection needs to be opened. If such a conventional database connection pooler is placed near the database, the initial overhead associated with the connection setup from the database client is higher than the split connection approach described herein. If such a conventional database connection pooler is placed near the database client, the overhead associated with creating database connections from the pool node to the database is higher than the split connection approach described herein. Further, placing a conventional database connection pooler near the database client introduces additional challenges, such as determining how many connections to keep open to the database, since multiple connection poolers would need to operate in various locations in a distributed database service. If such a conventional database connection pooler is placed somewhere in the middle, both the initial overhead associated with the connection setup from the database client and the overhead of creating connections from the pool node to the database are greater than with the split connection approach.

A database client makes a database connection request for the origin database. The database client may be a client that is external to the distributed database service or may be a client that is executing at the distributed database service. An internal client may be executing on the same machine as the client node and may be triggered from a request from an external client device. The database connection request for the origin database is received at any of the client nodes. In either case, the client node that receives the database connection request is typically physically close to the database client. The client node establishes a database connection for the origin database at the distributed database service with the database client. This database connection is the client-side connection of the split database connection. Establishing this database connection can include a TCP handshake, TLS negotiation, and/or authentication. From the database client's perspective, it appears as if they are connected with the origin database even though they are connected with a database service at the client node. Due to the client node's position at the edge of the distributed database service (and thus closer to users), the initial database connection setup is faster compared to connecting directly to the database, which is multiplied by the number of round trips necessary to establish the database connection (e.g., upwards of seven round-trips for the TCP handshake, TLS negotiation, and authentication). This is because the database client may be closer to the client node than to the origin database.

After establishing a database connection, the client node can receive database queries from the database client. The database queries can be non-mutating queries (e.g., read queries) or mutating queries (e.g., write queries). The client node may use a local query result cache for the database (e.g., a cache of results of read queries). The local query result cache may be on the same physical machine as the client node or on another machine within the same data center. If the client node can respond to the query from its local query result cache (e.g., it is a read query whose result is cached), the client node returns the cached result of the query to the database client.

If the client node cannot respond to the query from its local query result cache (e.g., it is a mutating query or it is a read-only query whose result is not available in its local query result cache), the client node proxies the query to another node of the distributed database service. In one embodiment, the client node proxies the query to a caching node, which may be located within the same geographical region as the client node, if the query is a read query. The caching node maintains a cache of results of read-only queries which is shared by a group of client nodes. This query result cache is sometimes referred to as a group query result cache. The caching node determines whether it can respond to the query from the group query result cache. If the caching node can respond to the query from the group query result cache, the caching node returns the cached result to the client node which in turn returns the cached result to the database client. If the client node uses a local query result cache, the client node causes the result to be stored in the local query result cache. If the caching node cannot respond to the query from the group query result cache, the caching node proxies the query to a pool node.

In an embodiment, the pool node uses a query result cache. This query result cache is sometimes referred to as a pool query result cache. If the pool node can respond to the query from the pool query result cache, the pool node returns the result to the caching node, which in turn returns the result to the client node, which in turn returns the result to the database client.

The caching node caches the result. If the client node uses a local query result cache, the client node causes the result to be cached in the local query result cache. If the pool node cannot respond to the query from the pool query result cache, or if the pool node does not use a pool query result cache, the pool node connects to the origin database using one of the existing database connections from the set of database connection pools, and queries the origin database. If no database connection is available from the database connection pool, or if there is no database connection pool, the pool node establishes a new connection to the origin database and uses that connection for querying the origin database. The pool node receives the result from the origin database and returns the result to the caching node which in turn returns the result to the client node which in turn returns the result to the database client. The pool node may cause the result to be cached in the pool query result cache, if used. The caching node may cause the result to be cached in the group query result cache. The client node may cause the result to be cached in the local query result cache.

In another embodiment, the client node proxies the query to a pool node without proxying separately to a caching node. The pool node may use the pool query result cache. If the pool node can respond to the query from the pool query result cache, the pool node returns the result to the client node which in turn returns the result to the database client. If the client node uses a local query result cache, the client node causes the result to be cached in the local query result cache. If the pool node cannot respond to the query with results stored in the pool query result cache, or if the pool node does not use a pool query result cache, the pool node connects to the origin database using one of the existing database connections from the set of database connection pools, and queries the origin database. If no database connection is available from the database connection pool, or if there is no database connection pool, the pool node establishes a new connection to the origin database and uses that connection for querying the origin database. The pool node receives the result from the origin database and returns the result to the client node which in turn returns the result to the database client. The pool node may cause the result to be cached in the pool query result cache, if in use, and the client node may cause the result to be cached in the local query result cache, if in use.

In an embodiment, the location of the pool node in the distributed database service is based on a set of metrics and/or attributes. The set of metrics may include a set of one or more link metrics (e.g., from each data center to the origin database) and/or a set of compute server metrics. The set of link metrics can indicate the latency, monetary expense, throughput, bandwidth, and reliability of the links. The latency from a particular data center to a particular origin database (e.g., IP address or hostname) can be computed using network probes.

The probe data for data center-to-origin database links may determine (at a particular time) for each link, the network average round trip time (RTT), the network minimum RTT, the network maximum RTT, the network median RTT, the network standard deviation, jitter metrics on network RTT, packet loss rate, throughput, IP path MTU, AS path (including number of ASes in the path and which specific ASes are in the path), packet reordering, and/or packet duplication. The compute server metrics may indicate the compute resource availability, current processing cost (e.g., cost of CPU/hr). The set of attributes may include attributes of the data center or compute server such as location, country, legal jurisdiction, region, data center tier type, server/data center certification (e.g., ISO-certified, FedRAMP), server generation, server manufacturer, and/or processing capability (e.g., hardware configuration such as, CPU, GPU, hardware accelerator(s), co-processor(s), storage device type/size, memory type/size).

In an embodiment, the location of the pool node is established after the origin database is configured or updated in the distributed database service. The data centers that are eligible for placement of the pool node are determined. This determination may be made based on the attributes of the data center (e.g., location, country, legal jurisdiction, region, data center tier type, server/data center certification, server generation, server manufacturer, and/or processing capability) and may be based on policy/configuration provided by the customer. In some embodiments, for each data center that is eligible, a connection request is made from a server in that data center to the origin database, which may be done multiple times. The data center with the lowest average latency to the origin database (as determined by the connection requests) is selected as the location of the pool node.

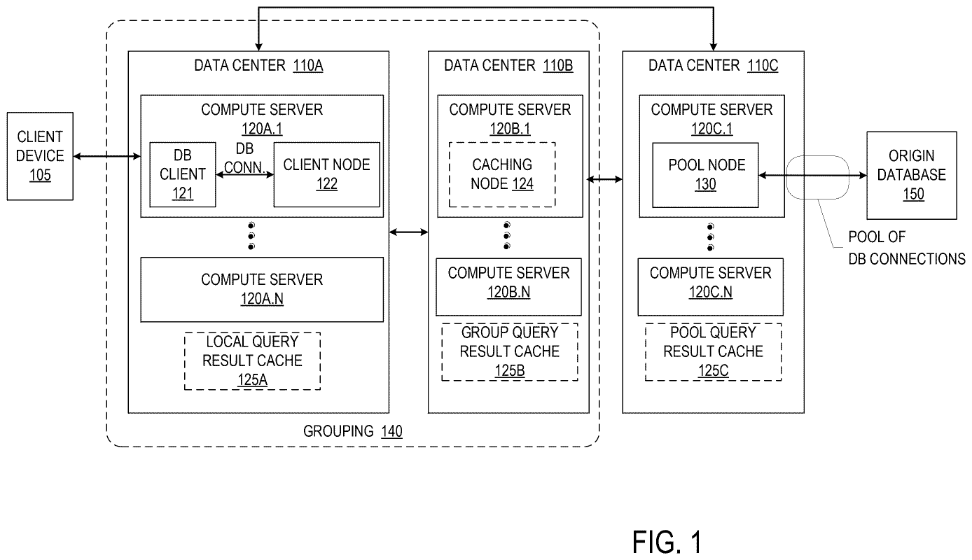

FIG. 1 illustrates a system for geographically split connection pooling for databases according to an embodiment. The distributed database service includes multiple data centers that are geographically distributed. FIG. 1 illustrates the data centers 110A, 110B, and 110C. The number of data centers is exemplary as there may be fewer or more data centers. Each data center includes one or more compute servers. For example, the data centers 110A-C include the compute servers 120A.1-N-120C.1-N respectively. Each data center can also include one or more control servers, one or more DNS servers (e.g., one or more authoritative name servers, one or more proxy DNS servers), and/or one or more other pieces of network equipment such as router(s), switch(es), and/or hubs.

Network traffic is received at the distributed database service. The network traffic can be received from client devices and may be a database query for the origin database 150. The traffic may be received at the distributed cloud computing network in different ways. For instance, IP address(es) of the origin network belonging to the origin database may be advertised (e.g., using Border Gateway Protocol (BGP)) by the distributed database service instead of being advertised by the origin network. As another example, the data centers of the distributed database service may advertise a different set of anycast IP address(es) on behalf of the origin and map those anycast IP address(es) to the origin IP address(es). This causes IP traffic to be received at the distributed database service instead of being received at the origin network. As another example, network traffic for a hostname of the origin database may be received at the distributed database service due to a DNS request for the hostname resolving to an IP address of the distributed database service instead of resolving to an IP address of the origin network. As another example, client devices may be configured to transmit traffic to the distributed database service. For example, an agent on the client device (e.g., a VPN client) may be configured to transmit traffic to the distributed database service. As another example, a browser extension or file can cause the traffic to be transmitted to the distributed database service. In any of the above scenarios, the network traffic from a client device may be received at a particular data center that is determined to be closest to the client device in terms of routing protocol configuration (e.g., Border Gateway Protocol (BGP) configuration) according to an anycast implementation as determined by the network infrastructure (e.g., router(s), switch(es), and/or other network equipment between the client device and the data centers) or by a geographical load balancer.

The compute servers of the data centers receive the network traffic. The compute servers in the distributed database service can take on different roles based on the location of the origin database and the location of the requester. A compute server may function as a client node that facilitates the initial database connection with a database client and query proxying between the database client and the origin database. A compute server may function as a caching node to provide cached results to queries. A compute server may function as a pool node that maintains a set of database connections to the origin database. Which role a particular compute server functions at any time depends on the proximity to the database client and the origin database. It is possible for a compute server to function as a client node for a particular origin database and also take a different role for another origin database (e.g., a caching node or a pool node).

A customer of the distributed database service configures their origin database 150 for use in the distributed database service. The configuration can include the IP address, or hostname, and port of the origin database 150; the database username; the database password associated with the username; and the name or type of the database that is being configured (e.g., PostgreSQL). The configuration can also include custom TLS certificates and/or keys for mutual authentication. The configuration can also include credentials for an encrypted tunnel that connects the origin database 150 with the distributed database service. This configuration can be provided by the customer through a common connection string format used by database drivers. For example, if the origin database is a PostgreSQL database, the configuration can be received from a database connection string that takes the format: postgres://username: password@hostname_or_IP_dddress:port/database_name. The database connection string may be available from the provider of the origin database 150. As an alternative to providing a database connection string, the customer can provide explicit parameters for configuring their origin database 150 for use in the distributed database service (e.g., the IP address (or hostname) and port, the username, the password, and the name of the database). A configuration server of the distributed database service receives the configuration and creates a dynamic database connection string for the origin database in the distributed database service. This dynamic database connection string is then used by a database client to make a connection for the origin database. This dynamic database connection string for the database client to connect to the origin database via the client node may use different credentials from the credentials used by the pool node to connect to the origin database.

In the example of FIG. 1, the origin database 150 has been configured for use in the distributed database service. The origin database 150 is connected with the compute server 120C.1 of the data center 110C. In this example, the compute server 120C.1 functions as a pool node for the origin database 150. The compute server 120C.1 includes the database pool node 130 that maintains a pool of database connections with the origin database 150. This pool of database connections is a collection of pre-established connections to the origin database 150 that are maintained by the database pool node 130. These pre-established connections can be reused, which improves performance. Instead of establishing a new database connection with the origin database 150, a connection from the pool can be used. Other compute servers that receive a database query for the origin database 150 can proxy that query to the compute server 120C.1 which then transmits the query to the origin database 150 over one of the pre-established database connections. The pool of database connections is the server-side connection of the split database connection.

A database client makes a database connection request for the origin database 150 that is processed by a client node. The database client may be an internal client that is executing on the same machine as the client node. Alternatively, the database client may be an external client that is executing at a device that is external to the distributed database service. As illustrated in FIG. 1, a database client 121 is executing on the compute server 120A.1. The database client 121 may be dynamically created as a result of code that is executing on the compute server 120A.1 that is triggered from a request from the client device 105.

An incoming connection for the origin database 150 is received at any of the client nodes, depending on the location of the requester. In the case of an internal database client, the compute server that receives the incoming connection is typically in a data center that is closest to the client device 105 out of the data centers of the distributed database service. For example, the compute server 120A.1 receives an incoming connection for the origin database 150 that is triggered from the client device 105 because the compute server 120A.1 is within the data center 110A that is closest to the client device 105 out of the data centers 110A-110N. If the database client is an external client, the compute server that receives the incoming connection is typically within a data center that is closest to the device executing the external client out of the data centers of the distributed database service. Thus, in either case, the client node that receives the incoming connection for the origin database 150 is typically physically close to the database client. The pool node 130 may be physically closer to the origin database 150 compared to the client node 122. For example, the client node 122 may be executing on a first compute server that is located in a first geographic region, the pool node 130 may be executing on a compute server that is located in a second, different, geographic region, and the origin database 150 may be located in the second geographic region.

The database client 121 is configured to use the dynamic database connection string to make a connection for the origin database 150. A database connection is established between the database client 121 and the client node 122. This database connection is the client-side connection of the split database connection. The client node 122 performs the initial database connection and authentication with the database client 121. Establishing the database connection can include a TCP handshake, TLS negotiation, and/or authentication. From the database client's perspective, it appears as if they are connected with the origin database 150 even though they are connected with the client node 122. The initial database connection setup is faster compared to connecting directly to the database, which is multiplied by the number of round trips necessary to establish the database connection (e.g., upwards of seven round-trips for the TCP handshake, TLS negotiation, and authentication). This is because the database client 121 is closer to the client node 122 than to the origin database 150. The client node 122 also proxies database queries to a caching node or a pool node. The client node 122 may use a local query result cache to respond to queries with cached data in some embodiments.

After establishing the initial database connection, the client node 122 receives a query for the origin database 150 from the database client 121. The client node 122 determines whether the query is a type that produces a cacheable result. If the query is a non-mutating query (e.g., a read-only query that does not modify any data in the origin database 150), it is considered suitable for caching. If the query is a mutating query (e.g., if it will modify data in the origin database 150) or if the query uses functions designated as volatile, it is not suitable for caching.

The client node 122 determines whether the query is non-mutating, mutating, or volatile by analyzing the query and its operation. In an embodiment, the query is treated as mutating if it includes any statement that modifies data in the origin database 150 (e.g., CREATE, ALTER, DROP, INSERT, UPDATE, DELETE), and the query is treated as non-mutating if it does not include any statement that modifies data in the in the origin database 150 and does not use any function designated as volatile.

If the query is a type that does not produce a cacheable result (e.g., if it is a mutating query or uses a volatile function), the client node 122 proxies the query towards the compute server that holds the pool of database connections with the origin database 150. For example, the client node 122 proxies the query to the compute server 120C.1 that is acting as a pool node that holds the pool of database connections with the origin database 150. The proxying of the query may go through multiple compute servers of the distributed database service until the query is received at the compute server 120C.1. The pool node 130, which maintains a pool of database connections with the origin database 150, transmits the query to the origin database 150 over one of the pre-established database connections. If no database connection is available from the database connection pool, or if there is no database connection pool, the pool node 130 establishes a connection to the origin database 150 and queries the origin database 150 using the established connection. The pool node 130 receives the result from the origin database 150 and returns the result to the client node 122 which in turn returns the result to the database client 121.

If the query is a type that produces a cacheable result (e.g., it is a non-mutating query), the result of the query may be returned from a query result cache in the distributed database service. The distributed database service may use a multi-tier cache service to cache query results. For example, a first tier may be a local cache that is used by the client nodes locally, referred herein as a local query result cache; a second tier may be a group cache that is used by caching nodes that is referred herein as a group query result cache; and a third tier may be a top-level cache that is used by a pool node that is referred herein as a pool query result cache. One or more of these tiers may not be used.

In an embodiment, the client node 122 uses a query result cache (e.g., a cache of results of read queries) such as the local query result cache 125A. The local query result cache 125A may be on the same physical machine as the client node 122 (e.g., part of the compute server 120A.1) or on another machine within the same data center 110A as the client node 122. If the client node 122 can respond to the query from the local query result cache 125A (e.g., a result for the query is cached in the local query result cache 125A), the client node 122 retrieves the cached result from the local query result cache 125A and returns the result to the database client 121.

If the client node 122 does not use a query result cache or a cached result is not available in the local query result cache 125A, the client node 122 proxies the database query to another server in the distributed database service. In an embodiment, the distributed database service includes one or more caching nodes for the origin database 150. In the example of FIG. 1, the compute server 120B.1 is a caching node for the origin database 150 that serves a group of client nodes, including the client node 122. There may be multiple caching nodes in the distributed database service, such as one per logical grouping. The logical grouping may be at a geographical region. For example, there may be a caching node that is located at each geographical region that serves the client nodes within that geographical region. As illustrated in FIG. 1, the data center 110A and the data center 110B are part of the same logical grouping 140. In such an embodiment, the client node proxies the database query to a caching node. For instance, with respect to FIG. 1, the client node 122 proxies the database query to the caching node 124.

The caching node 124 maintains a cache of results of read-only queries, which is shared by a group of client nodes. This cache is shown as the group query result cache 125B in FIG. 1. The group query result cache 125B may be on the same physical machine as the caching node 124 (e.g., part of the compute server 120B.1) or on another machine within the same data center 110B as the caching node 124. The caching node 124 receives the proxied query and determines whether it can respond to the query from the group query result cache 125B (e.g., a result for the query is cached in the group query result cache 125B). If the caching node 124 can respond to the query from the group query result cache 125B (a cache hit), the caching node 124 returns the cached result to the client node 122 which in turn returns the cached result to the database client 121. If the client node 122 uses a local query result cache, the client node 122 causes the result to be cached in the local query result cache 125A. If the caching node 124 cannot respond to the query from its cache (a result of the query is not in the local query result cache 125A), the caching node 124 proxies the query to a pool node 130.

The pool node 130 receives the proxied query. In embodiments where the pool node 130 uses a query result cache, such as the pool query result cache 125C, the pool node 130 accesses the cache to determine whether it can respond to the query from the cache. If it can, the pool node 130 returns the cached result to the caching node 124 which in turn returns the result to the client node 122 which in turn returns the result to the database client 121. The caching node 124 caches the result in the group query result cache 125B. If the client node 122 uses a query result cache, the client node 122 causes the result to be cached in the local query result cache 125A. If the pool node cannot respond to the query from a cache (e.g., the result is not cached or it does not use a query result cache), the pool node 130 connects to the origin database 150 using one of the existing database connections from the set of database connection pools, and queries the origin database 150. If no database connection is available from the database connection pool, or if there is no database connection pool, the pool node 130 establishes a new connection to the origin database 150 and queries the origin database 150 using the new connection. The pool node 130 receives the result from the origin database 150 and returns the result to the caching node 124 which in turn returns the result to the client node 122 which in turn returns the result to the database client 121. The pool node 130 may cause the result to be cached in the pool query result cache 125C if used, the caching node 124 may cause the result to be cached in the group query result cache 125B, and the client node 122 may cause the result to be cached in the local query result cache 125A if used.

In an embodiment where the distributed database service does not include one or more caching nodes, the client node 122 proxies the query to the pool node 130 directly. In embodiments where the pool node 130 has a query result cache for the origin database 150 such as the pool query result cache 125C, the pool node 130 accesses the cache to determine whether it can respond to the query from the cache. If it can, the pool node 130 returns the cached result to the client node 122 which in turn returns the result to the database client 121. If the client node 122 uses a query result cache, the client node 122 causes the result to be cached in the local query result cache 125A. If the pool node cannot respond to the query from a query result cache (e.g., the result is not cached or it does not use a query result cache), the pool node 130 connects to the origin database 150 using one of the existing database connections from the set of database connection pools, and queries the origin database 150. If no database connection is available from the database connection pool, or if there is no database connection pool, the pool node 130 establishes a new connection to the origin database 150 and queries the origin database 150 using the new connection. The pool node 130 receives the result from the origin database 150 and returns the result to the client node 122 which in turn returns the result to the database client 121. The pool node 130 may cause the result to be cached in the pool query result cache 125C if used, and the client node 122 may cause the result to be cached in the local query result cache 125a if used.

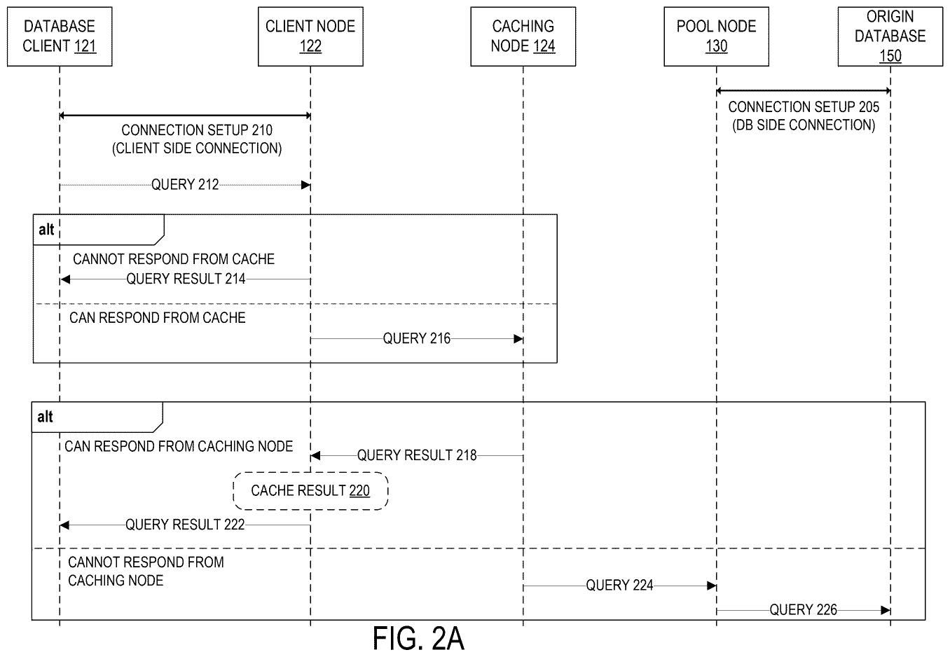

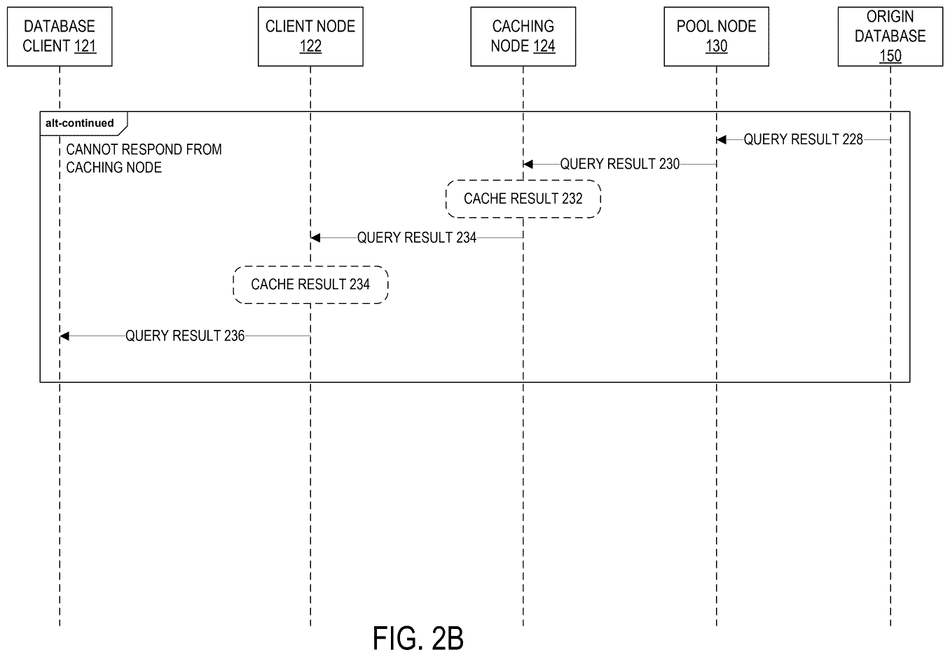

FIG. 2A is a first part of a sequence diagram that illustrates exemplary operations for geographically split connection pooling for a database according to an embodiment. FIG. 2B is a second part of the sequence diagram that illustrates exemplary operations for geographically split connection pooling for a database. In the embodiment of these figures, the distributed database service includes one or more caching nodes. Prior to the operations of FIGS. 2A-B, the origin database 150 has been configured for use in the distributed database service.

At operation 205, the pool node 130 establishes a set of one or more database connections with the origin database 150 to create a pool of database connections. These database connection(s) are database-side connection(s) of the split database connection.

Establishing a database connection with the origin database 150 includes a TCP handshake, TLS negotiation, and/or authentication. The credentials used to establish a database connection with the origin database 150 may be different from the credentials used by the database client when establishing a connection with the client node.

At operation 210, the database client 121 and the client node 122 perform a database connection setup for the origin database 150. This database connection is the client-side connection of the split database connection. This database connection setup includes a TCP handshake, TLS negotiation, and/or authentication. In a case where the database client 121 is an internal client, the database client 121 may not need to establish a TCP connection or TLS session with the client node 122. In a case where the database client 121 is an external client, the database client 121 typically establishes a TCP connection and TLS session with the client node 122. Due to the position of the client node 122 at the edge of the distributed database service (and thus closer to users), the initial database connection setup is faster compared to connecting directly to the origin database 150, which is multiplied by the number of round trips necessary to establish the database connection (e.g., upwards of seven round-trips for the TCP handshake, TLS negotiation, and authentication). This is because the database client 121 is closer to the client node 122 than to the origin database 150. In some embodiments, the database client 121 and the client node 122 are on the same machine.

After the database connection is established, the database client 121 transmits a database query for the origin database 150 that is received at the client node 122 at operation 212 The client node 122 receives the database query and determines whether the query is a type that returns a result that is cacheable. In embodiment, a non-mutating query (a read-only query) is cacheable, a mutating query is not cacheable, and a query that uses a function designated as volatile is not cacheable. The client node 122 determines whether the query is non-mutating, mutating, or volatile by analyzing the query and its operation. In the example of FIGS. 2A-B, the query is a non-mutating query and is thus cacheable.

The client node 122 may use a query result cache for the database (e.g., a cache of results of read queries such as the local query result cache 125A). If the client node 122 can respond to the query from the local query result cache 125A, then the client node 122 returns the query result to the database client 121 at operation 214. If the client node 122 cannot respond to the query from the local query result cache 125A, then the client node 122 proxies the query to the caching node 124 at operation 216. The caching node 124 may be within the same logical grouping as the client node 122 (e.g., same geographical region).

The caching node 124 maintains a cache of results of read-only queries that is shared by a group of client nodes including the client node 122. The caching node 124 determines whether it can respond to the query from the group query result cache 125B. If the caching node 124 can respond to the query from the group query result cache 125B, then at operation 218 the caching node 124 returns the cached result to the client node 122. If the client node 122 uses a local query result cache, the client node 122 caches the result in the local query result cache 125A at operation 220. The client node 122 returns the query result to the database client 121 at operation 222.

If the caching node 124 cannot respond to the query from the group query result cache 125B, the caching node 124 proxies the query to the pool node 130 at operation 224. In the example shown in this figure, the pool node 130 does not use a query result cache for the origin database 150. The pool node 130 transmits the query to the origin database 150 using one of the existing database connections from the set of database connection pools at operation 226. If no database connection is available from the database connection pool, or if there is no database connection pool, the pool node 130 establishes a new connection to the origin database 150 and queries the origin database 150 using the new connection. The pool node 130 receives the query result from the origin database 150 at operation 228. The pool node 130 transmits the query result to the caching node 124 at operation 230. The caching node 124 caches the received result at operation 232 to the group query result cache 125B. The caching node 124 transmits the query result to the client node 122 at operation 234. The client node 122 caches the query result to the local query result cache 125A if the client node 122 uses a local query result cache at operation 234. The client node 122 returns the query result to the database client 121 at operation 236.

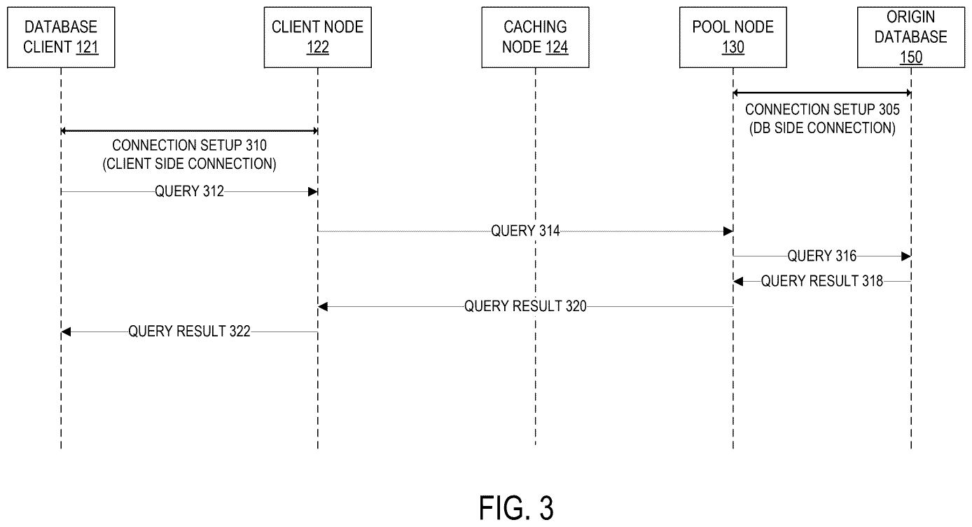

FIG. 3 is a sequence diagram that illustrates exemplary operations for geographically split connection pooling for a database according to an embodiment. Prior to the operations of FIG. 3, the origin database 150 has been configured for use in the distributed database service.

At operation 305, the pool node 130 establishes a set of one or more database connections with the origin database 150 to create a pool of database connections. These database connection(s) are database-side connection(s) of the split database connection.

Establishing a database connection with the origin database 150 includes a TCP handshake, TLS negotiation, and/or authentication. The credentials used to establish a database connection with the origin database 150 may be different from the credentials used by the database client when establishing a connection with the client node.

At operation 310, the database client 121 and the client node 122 perform a database connection setup for the origin database 150. This database connection is the client-side connection of the split database connection. This database connection setup includes a TCP handshake, TLS negotiation, and/or authentication. In a case where the database client 121 is an internal client, the database client 121 may not need to establish a TCP connection or TLS session with the client node 122. In a case where the database client 121 is an external client, the database client 121 typically establishes a TCP connection and TLS session with the client node 122. Due to the position of the client node 122 at the edge of the distributed database service (and thus closer to users), the initial database connection setup is faster compared to connecting directly to the origin database 150, which is multiplied by the number of round trips necessary to establish the database connection (e.g., upwards of seven round-trips for the TCP handshake, TLS negotiation, and authentication). In some embodiments, the database client 121 and the client node 122 are on the same machine.

After the database connection is established, the database client 121 transmits a database query for the origin database 150 that is received at the client node 122 at operation 312.

The client node 122 receives the database query and determines whether the query is a type that returns a result that is cacheable. In embodiment, a non-mutating query (a read-only query) is cacheable, a mutating query is not cacheable, and a query that uses a function designated as volatile is not cacheable. The client node 122 determines whether the query is non-mutating, mutating, or volatile by analyzing the query and its operation. In the example of FIG. 3, the query is a type that does not return a result that is cacheable (e.g., it is a mutating query or a query that uses a function designated as volatile).

At operation 314, the client node 122 proxies the query to the pool node 130. The pool node 130 transmits the query to the origin database 150 using one of the existing database connections from the set of database connection pools at operation 316. If no database connection is available from the database connection pool, or if there is no database connection pool, the pool node 130 establishes a new connection to the origin database 150 and queries the origin database 150 using the new connection. The pool node 130 receives the query result from the origin database 150 at operation 318. The pool node 130 transmits the query result to the client node 122 at operation 320. The client node 122 transmits the query result to the database client 121 at operation 322.

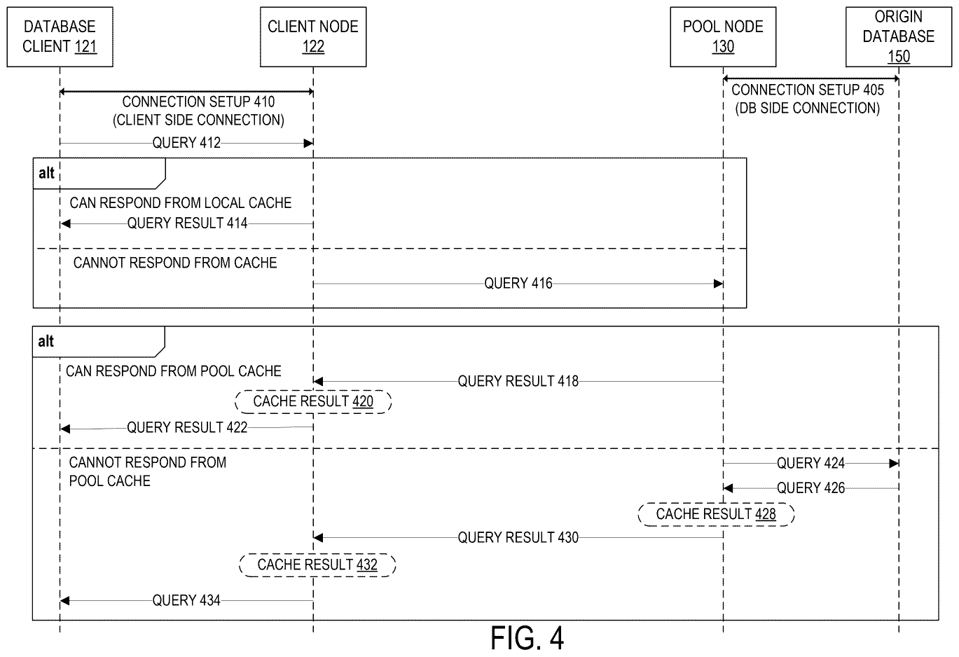

FIG. 4 is a sequence diagram that illustrates exemplary operations for geographically split connection pooling for a database according to an embodiment. In the embodiment of FIG. 4, the distributed database service does not include caching node(s). Prior to the operations of FIG. 4, the origin database 150 has been configured for use in the distributed database service.

At operation 405, the pool node 130 establishes a set of one or more database connections with the origin database 150 to create a pool of database connections. These database connection(s) are database-side connection(s) of the split database connection.

Establishing a database connection with the origin database 150 includes a TCP handshake, TLS negotiation, and/or authentication. The credentials used to establish a database connection with the origin database 150 may be different from the credentials used by the database client when establishing a connection with the client node.

At operation 410, the database client 121 and the client node 122 perform a database connection setup for the origin database 150. This database connection is the client-side connection of the split database connection. This database connection setup includes a TCP handshake, TLS negotiation, and/or authentication. In a case where the database client 121 is an internal client, the database client 121 may not need to establish a TCP connection or TLS session with the client node 122. In a case where the database client 121 is an external client, the database client 121 typically establishes a TCP connection and TLS session with the client node 122. Due to the position of the client node 122 at the edge of the distributed database service (and thus closer to users), the initial database connection setup is faster compared to connecting directly to the origin database 150, which is multiplied by the number of round trips necessary to establish the database connection (e.g., upwards of seven round-trips for the TCP handshake, TLS negotiation, and authentication). In some embodiments, the database client 121 and the client node 122 are on the same machine.

After the database connection is established, the database client 121 transmits a database query for the origin database 150 that is received at the client node 122 at operation 412. The client node 122 receives the database query and determines whether the query is a type that returns a result that is cacheable, like as previously described. In the example of FIG. 4, the query is a type that returns a result that is cacheable (e.g., it is a non-mutating query).

The client node 122 may use a query result cache for the database (e.g., a cache of results of read queries such as the local query result cache 125A). If the client node 122 can respond to the query from the local query result cache 125A, then the client node 122 returns the query result to the database client 121 at operation 414. If the client node 122 cannot respond to the query from the local query result cache 125A, then the client node 122 proxies the query to the pool node 130 at operation 416.

In the example shown in FIG. 4, the pool node 130 uses a query result cache for the origin database 150 (e.g., the pool query result cache 125C). The pool node 130 determines whether it can respond to the query from the pool query result cache 125C. If it can, the pool node 130 transmits the cached query result to the client node 122 at operation 418. The client node 122 caches the query result to the local query result cache 125A if the client node 122 uses a local query result cache at operation 420. The client node 122 returns the query result to the database client 121 at operation 422. If the pool node 130 cannot respond to the query from the pool query result cache 125C (e.g., the result is not cached), the pool node 130 transmits the query to the origin database 150 using one of the existing database connections from the set of database connection pools at operation 424. If no database connection is available from the database connection pool, or if there is no database connection pool, the pool node 130 establishes a new connection to the origin database 150 and queries the origin database 150 using the new connection. The pool node 130 receives the query result from the origin database 150 at operation 426. The pool node 130 caches the received query result in the pool query result cache 125C at operation 428. The pool node 130 transmits the query result to the client node 122 at operation 430. The client node 122 caches the query result to the local query result cache 125A if the client node 122 uses a local query result cache at operation 432. The client node 122 returns the query result to the database client 121 at operation 434.

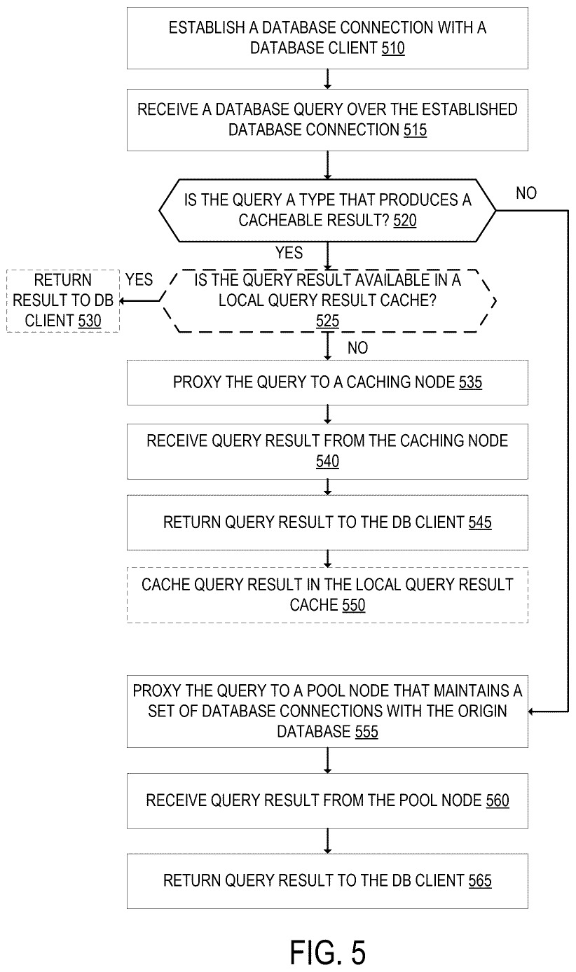

FIG. 5 is a flow diagram that illustrates exemplary operations for geographically split connection pooling for a database according to an embodiment. The operations of FIG. 5 are performed from the perspective of a client node, such as the client node 122. The operations of FIG. 5, and the other flow diagrams, are described with reference to the exemplary embodiment of FIG. 1. However, the operations of FIG. 5, and the other flow diagrams, can be performed by embodiments different from FIG. 1; and the embodiment of FIG. 1 can perform operations different from the operations of FIG. 5 and the other flow diagrams.

At operation 510, the client node 122 establishes a database connection with the database client 121 for the origin database 150. This database connection is a client-side connection of the split connection. Establishing the database connection may include terminating a TCP connection, terminating a TLS connection, and/or performing authentication to the database. As an example, if the database client 121 is an internal client that is executing on the same machine as the client node 122, a TCP connection and/or a TLS session may not need to be established between the database client 121 and the client node 122. For example, instead of communicating over TCP, the database client 121 and the client node 122 can communicate using a different inter-process communication technique (e.g., Unix domain sockets, shared memory, memory-mapped files, pipes, etc.). If the database client 121 is an external client, the database client 121 typically establishes a TCP connection and a TLS session with the client node 122.

Prior or concurrent with operation 510, a set of one or more database connections may be established from the pool node 130 to the origin database 150 (database-side connection(s) of the split connection).

At operation 515, the client node 122 receives a database query from the database client 121 over the established client-side database connection. The query may be a mutating query or a non-mutating query. At operation 520, the client node 122 determines whether the query is a type that produces a cacheable result. The client node 122 may determine whether the query is non-mutating, mutating, or volatile by analyzing the query and its operation. If the query is a type that produces a cacheable result, then operation 525 is performed. If the query is not a type that produces a cacheable result, then operation 555 is performed.

At operation 525, which is performed in an embodiment where the client node 122 uses a local query result cache such as the local query result cache 125A, the client node 122 determines whether the query result is available in the local query result cache 125A. If it is, the client node 122 returns the result to the database client 121 at operation 530. If the query result is not available in the local query result cache 125A, then operation 535 is performed.

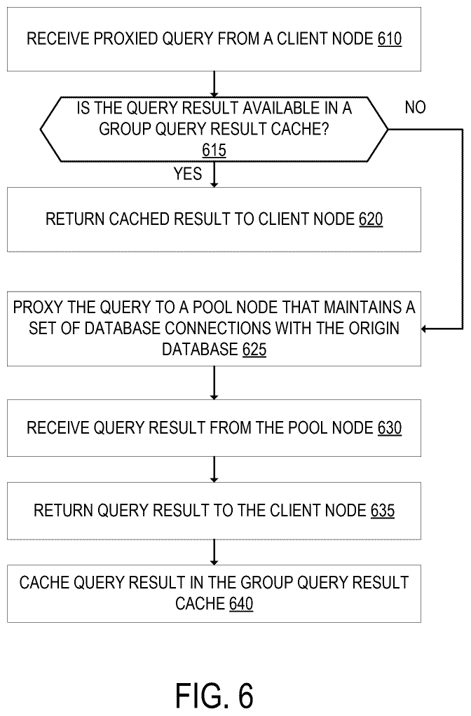

At operation 535, the client node 122 proxies the query to the caching node 124. The operations of the caching node 124 are described with reference to FIG. 6. At operation 540, the client node 122 receives the query result from the caching node 124. At operation 545, the client node 122 returns the query result to the database client 121. At operation 550, which is performed in an embodiment where the client node 122 uses a local query result cache, the client node 122 caches the query result in the local query result cache 125A.

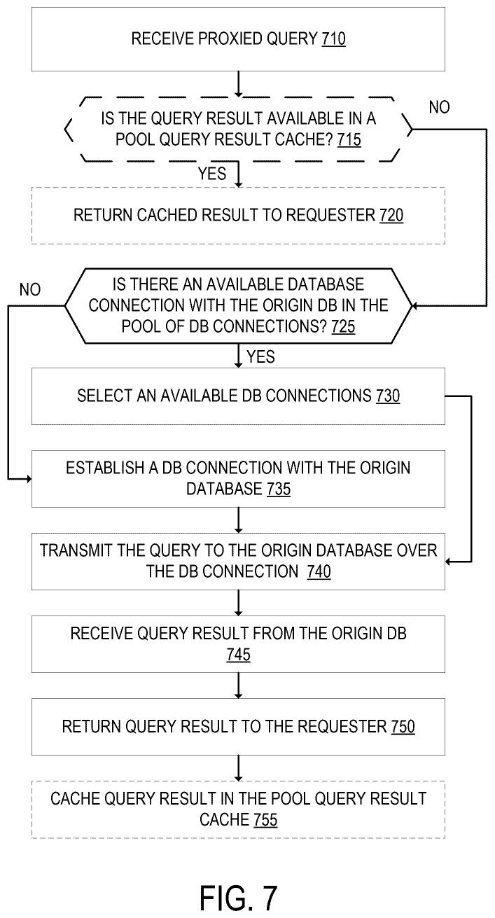

At operation 555 (the query is not a type that produces a cacheable result), the client node 122 proxies the query to the pool node 130. The operations of the pool node 130 are described with reference to FIG. 7. At operation 560, the client node 122 receives the query result from the pool node. At operation 565, the client node 122 returns the query result to the database client 121.

FIG. 6 is a flow diagram that illustrates exemplary operations for geographically split connection pooling for a database according to an embodiment. The operations of FIG. 6 are performed from the perspective of a caching node, such as the caching node 124.

At operation 610, the caching node 124 receives a proxied query from the client node 122. In an embodiment, the proxied query should be of a type that produces a cacheable result. At operation 615, the caching node 124 determines whether the query result is available in the group query result cache 125B. If it is, then operation 620 is performed where the caching node 124 returns the cached query result to the client node 122. If the query result is not available in the group query result cache 125B, then operation 625 is performed where the caching node 124 proxies the query to the pool node 130. At operation 630, the caching node 124 receives the query result from the pool node 130. At operation 635, the caching node 124 returns the query result to the client node 122. At operation 640, the caching node 124 caches the query result in the group query result cache 125B.

FIG. 7 is a flow diagram that illustrates exemplary operations for geographically split connection pooling for a database according to an embodiment. The operations of FIG. 7 are performed from the perspective of a pool node, such as the pool node 130.

At operation 710, the caching node 124 receives a proxied query. The proxied query may be received from a client node such as the client node 122, or from a caching node such as the caching node 124. At operation 715, which is performed if the pool node 130 uses a query result cache such as the pool query result cache 125C, the pool node 130 determines whether a query result is available in the pool query result cache 125C. If it is, then operation 720 is performed where the pool node 130 returns the cached result to the requester (e.g., the caching node 124). If the query result is not available in the pool query result cache 125C, then operation 725 is performed.

At operation 725, the pool node 130 determines whether there is an available database connection out of the pool of database connections with the origin database 150. If there is, the pool node 130 selects one of them at operation 730 and flow moves to operation 740. If there is not an available database connection, then at operation 735 the pool node 130 establishes a database connection with the origin database 150 and flow moves to operation 740. During operation 735, if an existing database connection becomes available, the pool node 130 may use that newly available database connection instead of waiting for the newly created connection to be ready. Although not illustrated in FIG. 7, there may be a limit to how many connections that are allowed to be open to the origin database 150. If the limit has been reached, the pool node 130 may wait for a connection to become available instead of establishing a new connection.

At operation 740, the pool node 130 transmits the query to the origin database 150 over the database connection. The origin database 150 executes the query and returns a result to the pool node 130. At operation 745, the pool node 130 receives the query result from the origin database 150. The pool node 130 returns the query result to the requester (the client node 122 or the caching node 124) at operation 750. At operation 755, which is performed if the pool node 130 uses a pool query result cache and the type of query is one that produces a cacheable result, caches the query result in the pool query result cache 125C.

In the preceding description, various components are described as proxying the query to another server in the distributed database service. For example, the client node can proxy a query to a caching node and/or a pool node; and the caching node can proxy a query to a pool node. The connections between these servers may be preestablished for use. This means that a particular server does not need to wait for the connections to be established, which may include TCP and TLS handshakes, when proxying data to another server in the distributed database service.

Further, a server determines which other server to proxy the query based on configuration, through consistent hashing, or through a lookup service. In a configuration based approach, the server is configured with a list of one or more data centers or one or more servers. For example, the server with the client node can be configured with a list of data center(s) and/or server(s) that implement a caching node and/or pool node for the origin database. The client node can use such a configuration when proxying the query. In a consistent hashing approach, consistent hashing is used to assign the roles for the origin database (caching node(s), pool node(s)) to specific data center(s) and/or server(s). A client node uses the same consistent hashing approach when receiving a database query to determine which data center and/or server to which it should proxy the query. In a lookup service approach, a lookup service can be used to dynamically provide the client node with the data center and/or server that implements a caching node and/or pool node for the origin database. The client node can use the lookup service to determine which data center and/or server to which it should proxy the query.

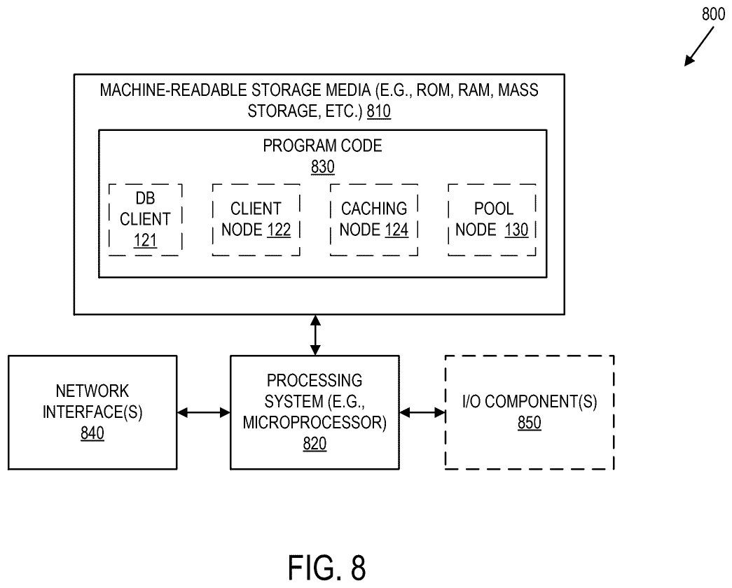

FIG. 8 illustrates a block diagram for an exemplary data processing system 800 that may be used in some embodiments. One or more such data processing systems 800 may be utilized to implement the embodiments and operations described with respect to a compute server or other servers described herein. Data processing system 800 includes a processing system 820 (e.g., one or more processors and connected system components such as multiple connected chips).

The data processing system 800 is an electronic device that stores and transmits (internally and/or with other electronic devices over a network) code (which is composed of software instructions and which is sometimes referred to as computer program code or a computer program) and/or data using machine-readable media (also called computer-readable media), such as machine-readable storage media 810 (e.g., magnetic disks, optical disks, read only memory (ROM), flash memory devices, phase change memory) and machine-readable transmission media (also called a carrier) (e.g., electrical, optical, radio, acoustical or other form of propagated signals-such as carrier waves, infrared signals), which is coupled to the processing system 820. For example, the depicted machine-readable storage media 810 may store program code 830 that, when executed by the processing system 820, causes the data processing system 800 to execute the database client 121, the client node 122, the caching node 124, and/or the pool node 130, and/or any of the operations described herein.

The data processing system 800 also includes one or more network interfaces 840 (e.g., a wired and/or wireless interfaces) that allows the data processing system 800 to transmit data and receive data from other computing devices, typically across one or more networks (e.g., Local Area Networks (LANs), the Internet, etc.). The data processing system 800 may also include one or more input or output (“I/O”) components 850 such as a mouse, keypad, keyboard, a touch panel or a multi-touch input panel, camera, frame grabber, optical scanner, an audio input/output subsystem (which may include a microphone and/or a speaker), other known I/O devices or a combination of such I/O devices. Additional components, not shown, may also be part of the system 800, and, in certain embodiments, fewer components than that shown in One or more buses may be used to interconnect the various components shown in FIG. 8.

The techniques shown in the figures can be implemented using code and data stored and executed on one or more electronic devices (e.g., an intermediary server). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable communication media (e.g., electrical, optical, acoustical or other form of propagated signals-such as carrier waves, infrared signals, digital signals). In addition, such electronic devices typically include a set of one or more processors coupled to one or more other components, such as one or more storage devices (non-transitory computer-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. Of course, one or more parts of an embodiment of the invention may be implemented using different combinations of software, firmware, and/or hardware.

References in the specification to “one embodiment,” “an embodiment,” “an example embodiment,” etc., indicate that the embodiment described may include a particular feature, structure, or characteristic, but every embodiment may not necessarily include the feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the preceding description and the claims, the terms “coupled” and “connected,” along with their derivatives, may be used. These terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

While the flow diagrams in the figures show a particular order of operations performed by certain embodiments of the invention, such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims.

The description is thus to be regarded as illustrative instead of limiting.

1. A method, comprising:
establishing, at a first server of a distributed database service, a client-side database connection between a client node of the first server and a database client of the first server, wherein the client-side database connection is for a database that is external to the distributed database service, wherein the database client issues queries directed to the database, and wherein establishing the client-side database connection includes performing authentication to the database;
receiving, at the first server, a first database query over the client-side database connection;
responsive to determining that the first server cannot respond to the first database query using a cache that is locally available to the first server, selecting a second server from a plurality of servers of the distributed database service based on the second server being located physically closer to the database than the first server, and proxying, by the client node of the first server of the distributed database service, the first database query to the second server of the distributed database service, wherein the second server includes a pool node for the database that maintains a plurality of pre-established database connections to the database for handling queries directed to the database;
receiving, from the second server, a first response to the first database query; and
transmitting the first response to the first database query to the database client.

2. The method of claim 1, further comprising:
receiving, at the first server, a second database query over the client-side database connection;
responsive to determining that the second database query is a type that produces a cacheable result, proxying the second database query to a third server that maintains a group cache of results of read-only queries for the database;
receiving, from the third server, a second response to the second database query; and
transmitting the second response to the second database query to the database client.

3. The method of claim 1, wherein the database client is executed on the first server that is triggered by a request received from a client device that is external to the distributed database service.

4. The method of claim 3, wherein the distributed database service includes a plurality of data centers, wherein the first server is at a first data center of the plurality of data centers, wherein the second server is at a second data center of the plurality of data centers, and wherein the client-side database connection is established at the first server of the distributed database service as a result of the first data center being determined to be closest to the client device out of the plurality of data centers.

5. The method of claim 1, wherein the database client is executed on a device that is external to the distributed database service, wherein the distributed database service includes a plurality of data centers, wherein the first server is at a first data center of the plurality of data centers, wherein the second server is at a second data center of the plurality of data centers, wherein the client-side database connection is established at the first server as a result of the first data center being determined to be closest to the device that is external to the distributed database service out of the plurality of data centers, and wherein establishing the client-side database connection for the database further includes terminating a TCP connection and terminating a TLS connection.

6. The method of claim 1, further comprising:
receiving, at the first server, a second database query over the client-side database connection;
generating a second response to the second database query using the cache that is locally available to the first server; and
transmitting the generated second response to the database client.

7. The method of claim 1, further comprising:
receiving configuration of the database from a customer of the distributed database service; and
creating a dynamic database connection string based on the configuration, the dynamic database connection string to be used by the database client for establishing the database connection.

8. The method of claim 1, wherein the first server is located in a first geographic region, wherein the second server is located in a second geographic region, and wherein a database server that manages the database is located in the second geographic region.

9. A non-transitory computer-readable storage medium that, if executed by a processing system of a first server, will cause the processing system to perform operations comprising:
establishing, at the first server of a distributed database service, a client-side database connection between a client node of the first server and a database client of the first server, wherein the client-side database connection is for a database that is external to the distributed database service, wherein the database client issues queries directed to the database, and wherein establishing the client-side database connection includes performing authentication to the database;
receiving, at the first server, a first database query over the client-side database connection;
responsive to determining that the first server cannot respond to the first database query using a cache that is locally available to the first server, proxying, by the client node of the first server of the distributed database service, the first database query to a second server of the distributed database service, wherein the second server includes a pool node for the database that maintains a plurality of pre-established database connections to the database for handling queries directed to the database, wherein the second server is located physically closer to the database compared to the first server;
receiving, from the second server, a first response to the first database query; and
transmitting the first response to the first database query to the database client.

10. The non-transitory computer-readable storage medium of claim 9, wherein the operations further comprise:
receiving, at the first server, a second database query over the client-side database connection;
responsive to determining that the second database query is a type that produces a cacheable result, proxying the second database query to a third server that maintains a group cache of results of read-only queries for the database;
receiving, from the third server, a second response to the second database query; and
transmitting the second response to the second database query to the database client.

11. The non-transitory computer-readable storage medium of claim 9, wherein the database client is executed on the first server that is triggered by a request received from a client device that is external to the distributed database service.

12. The non-transitory computer-readable storage medium of claim 11, wherein the distributed database service includes a plurality of data centers, wherein the first server is at a first data center of the plurality of data centers, wherein the second server is at a second data center of the plurality of data centers, and wherein the client-side database connection is established at the first server of the distributed database service as a result of the first data center being determined to be closest to the client device out of the plurality of data centers.

13. The non-transitory computer-readable storage medium of claim 9, wherein the database client is executed on a device that is external to the distributed database service, wherein the distributed database service includes a plurality of data centers, wherein the first server is at a first data center of the plurality of data centers, wherein the second server is at a second data center of the plurality of data centers, wherein the client-side database connection is established at the first server as a result of the first data center being determined to be closest to the device that is external to the distributed database service out of the plurality of data centers, and wherein establishing the client-side database connection for the database further includes terminating a TCP connection and terminating a TLS connection.

14. The non-transitory computer-readable storage medium of claim 9, wherein the operations further comprise:
receiving, at the first server, a second database query over the client-side database connection;
generating a second response to the second database query using the cache that is locally available to the first server; and
transmitting the generated second response to the database client.

15. The non-transitory computer-readable storage medium of claim 9, wherein the operations further comprise:
receiving configuration of the database from a customer of the distributed database service; and
creating a dynamic database connection string based on the configuration, the dynamic database connection string to be used by the database client for establishing the database connection.

16. A first server, comprising:
a processing system; and
a non-transitory machine-readable storage medium coupled to the processing system, wherein the non-transitory machine-readable storage medium stores instructions that, when executed by the processing system, causes the first server to perform operations including:
establishing, at the first server of a distributed database service, a client-side database connection between a client node of the first server and a database client of the first server, wherein the client-side database connection is for a database that is external to the distributed database service, wherein the database client issues queries directed to the database, and wherein establishing the client-side database connection includes performing authentication to the database;
receiving, at the first server, a first database query over the client-side database connection;
responsive to determining that the first server cannot respond to the first database query using a cache that is locally available to the first server, proxying, by the client node of the first server of the distributed database service, the first database query to a second server of the distributed database service, wherein the second server includes a pool node for the database that maintains a plurality of pre-established database connections to the database for handling queries directed to the database, wherein the second server is located physically closer to the database compared to the first server;
receiving, from the second server, a first response to the first database query; and
transmitting the first response to the first database query to the database client.

17. The first server of claim 16, wherein the operations further comprise:
receiving, at the first server, a second database query over the client-side database connection;
responsive to determining that the second database query is a type that produces a cacheable result, proxying the second database query to a third server that maintains a group cache of results of read-only queries for the database;
receiving, from the third server, a second response to the second database query; and
transmitting the second response to the second database query to the database client.

18. The first server of claim 16, wherein the database client is executed on the first server that is triggered by a request received from a client device that is external to the distributed database service.

19. The first server of claim 18, wherein the distributed database service includes a plurality of data centers, wherein the first server is at a first data center of the plurality of data centers, wherein the second server is at a second data center of the plurality of data centers, and wherein the client-side database connection is established at the first server of the distributed database service as a result of the first data center being determined to be closest to the client device out of the plurality of data centers.

20. The first server of claim 16, wherein the database client is executed on a device that is external to the distributed database service, wherein the distributed database service includes a plurality of data centers, wherein the first server is at a first data center of the plurality of data centers, wherein the second server is at a second data center of the plurality of data centers, wherein the client-side database connection is established at the first server as a result of the first data center being determined to be closest to the device that is external to the distributed database service out of the plurality of data centers, and wherein establishing the client-side database connection for the database further includes terminating a TCP connection and terminating a TLS connection.

21. The first server of claim 16, wherein the operations further comprise:
receiving, at the first server, a second database query over the client-side database connection;
generating a second response to the second database query using the cache that is locally available to the first server; and
transmitting the generated second response to the database client.

22. The first server of claim 16, wherein the operations further comprise:
receiving configuration of the database from a customer of the distributed database service; and
creating a dynamic database connection string based on the configuration, the dynamic database connection string to be used by the database client for establishing the database connection.
